(19) United States
(12) Patent Application Publication
(10) Pub. No.: US 2011/0078056 A1
(43) Pub. Date: Mar. 31, 2011

(54) Method for merchandising a product

(75) Inventors: Richard S. Polevov, Teaneck, NJ (US); Howard Scott Ryan, Skaneateles, NY (US); Paul Eric Carlson, Skaneateles, NY (US)

(73) Assignee: Finger Lake Intellectual Property LLC

(21) Appl. No.: 12/927,985

(22) Filed: Dec. 1, 2010

Related U.S. Application Data
(63) Continuation of application No. 11/236,327, filed on Sep. 27, 2005, now abandoned.
(60) Provisional application No. 60/613,389, filed on Sep. 27, 2004.

(51) Int. Cl. G06Q 30/00

(52) U.S. Cl. 705/27.2

(57) ABSTRACT

A method for merchandising a premium bed support system. The method includes advising various parties in the distribution system for selling a bed support system to a retail consumer as to the benefit of a premium bed support system so that the retail consumer has the opportunity of purchasing the premium bed support system in place of the standard bed support normally sold along with a bed. In the method, there can be a written document, such as a hangtag or other means at the retail furniture store that advises the retail consumer as to the advantages and benefits of the premium bed support system over the minimum bed support that qualify under the warranty of the bedding manufacturer.

### RELATED CASES

This application is based upon and thereby claims the priority to U.S. Provisional Application Ser. No. 60/613,389 filed Sep. 27, 2004 and entitled “METHOD FOR MERCHANDISING A PRODUCT”.

### FIELD OF THE INVENTION

The present invention relates to a method of merchandising a product, and, more particularly, to a method of merchandising a bed support to the end user for supporting a box spring and mattress that provides a premium level of support thereto.

### BACKGROUND OF THE INVENTION

There are four distinct competing and conflicting interests or parties that are involved in the purchase of case goods (wooden bedroom furniture), and more specifically, headboards, footboards and wooden side rails. Taking those interests individually:

I. Furniture Manufacturer

The furniture manufacturer supplies the wooden bedroom furniture and, at the present, there is no standard method to provide support for a mattress and box spring. The furniture manufacturers view supports or slats merely to provide a method of holding the mattress and box spring from falling through to the floor. The manufacturing process itself is driven to minimize material costs.

II. Bedding Manufacturers

All major bedding manufacturers universally require a bed frame with a rigid center support when selling their products. However, when the bedding is sold with wooden beds (those utilizing a headboard and a footboard) there has never been a standard system offered with quantifiable levels of support. The wording on warranty cards provided by bedding manufacturers typically refer to a support or the use of hardwood slats with headboards and footboards that utilize wood rails. The bedding manufacturers therefore have had to accept the support systems included with wooden beds because it is typically included as part of an overall package. The bedding warranty cards, however, require minimum levels of support.

III. Retail Furniture Store

The retail furniture stores typically order wooden beds complete with matching side rails and supports from the furniture manufacturers. The retail furniture stores normally include the support system in the price of the complete bed, that is, the headboard, footboard and rails. The delivery personnel are faced with a multitude of support systems that require varying degrees of skill and time to assemble, leading to installation errors. Furniture retailers do not focus any consumer attention on support systems.

IV. Retail Consumer

There is no perceived value on the part of the retail consumer with the wooden or metal support systems. Those systems are simply considered part of the hardware necessary to assemble a complete bed. Thus, the retail consumer is unaware of the problems associated with providing minimum levels of support that are inadequate to support luxury bedding that has substantially increased in weight. There are, therefore, increased warranty problems with bedding and increased service calls to retail furniture stores to re-adjust support systems that have failed.

The culmination of the above-described situation taking place between the differing parties has led to multiple problems for each of the four groups. Some of the problems are recognized within the group and some are not. Those responsible for particular problems are often misidentified. The issue of bedding failure at the consumer level is often cause for dissatisfaction and loss of future profit at the retail level although the furniture retailer in most cases is unaware of the issue and continues to pass the responsibility of the support system on to the furniture manufacturer. The bedding manufacturers see a higher rate of warranty claims but recognize the retail consumer as the issue for improper support rather than the retailer furniture store or furniture manufacturer. Resolving this issue would be a benefit to all parties involved.

### SUMMARY OF THE INVENTION

Recognizing the parties involved in the delivery of retail bedding and the problems that each group needed resolved, the present bed frame merchandising method was developed. This method introduces the system of up-selling a retail consumer a premium support at the point of sale of furniture, bedding and/or mattresses sets. The system involves the marketing of premium supports that far exceed the warranty and structural requirements for wood beds and mattress sets. The present method functions through the use of several unique marketing strategies. The entirety of the method is covered under the concept of the Bedbridge Certification Program.

In this program, the furniture is identified and labeled with hang tags or tent cards as being usable with the step-up premium support, thus calling the retail consumer's attention to the choice available. The method uses a modification to the warranty card provided by the bedding manufacturer in which not only is the minimum standard of mattress support shown but the preferred, premium support is identified and thereby endorsed. Additionally, brochures are produced which identify for both the retail sales associate and the retail consumer, the features and benefits of the premium support above those supports that they already own or may be included with a new bedding purchase.

Finally the method of the present invention calls for internet access of information and ordering of the premium supports. This allows the customer to step-up to a better support without the need for a brick and mortar store.

### BRIEF DESCRIPTION OF THE DRAWINGS

FIG. 1 is a diagram identifying the current relationships between the four interested parties involved in the purchase and distribution of case goods;

FIG. 2 is a diagram showing the relationship between the Bedbridge Certification Program for merchandising and the four interested parties;

FIG. 3 is a retail hangtag used with the present Bedbridge Certification Program;

FIG. 4 is an alternate embodiment of a hangtag for the present Bedbridge Certification Program;

FIG. 5 is an alternate embodiment of a hangtag for use with an existing clear hangtag pocket for the present Bedbridge Certification Program;

FIG. 6 shows a representation of a warranty card;

FIG. 7 represents an alternate embodiment of a warranty card;

FIG. 8. shows a point of purchase post spotlighting the information present on the warranty card;

FIG. 9 shows a point of purchase post spotlighting the information features and benefits of a premium support system;

FIG. 10 represents the appearance of an online warranty info and registration page for a mattress manufacture; and

FIG. 11 represents the appearance of an online retail webpage for information and purchase of the step up premium support bedbridge.

### DETAILED DESCRIPTION OF THE INVENTION

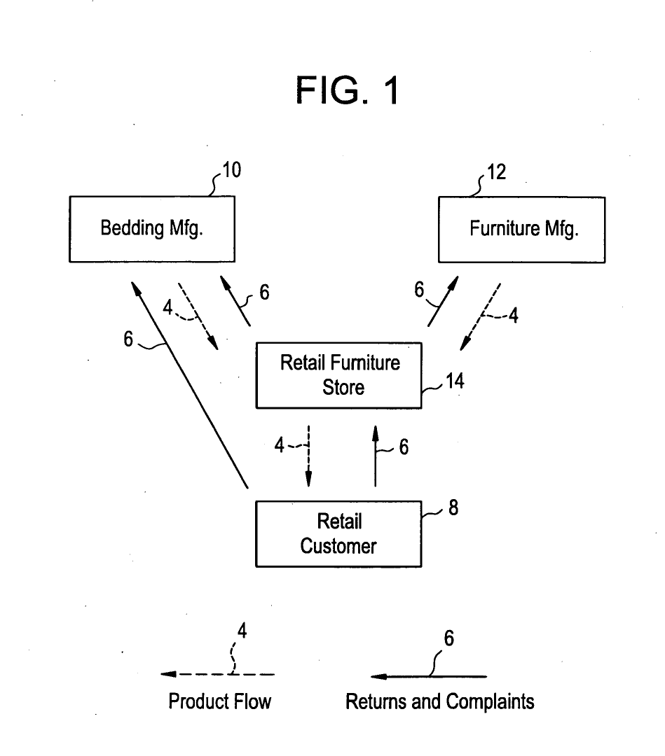

FIG. 1 represents the interaction currently of the aforedescribed four parties involved in the distribution of bedding. Interested parties are the bedding manufacturer 10, the furniture manufacturer 12 and the retail furniture store 14 and each of which are connected to the flow of product to the retail consumer 8 and each is in someway influenced by poor product performance and returns. The flow of the product is represented by the dotted arrows 4 and the returns and complaints are represented by the solid arrows 6. As can therefore be seen, the flow of product is from the bedding manufacturer 10 and the furniture manufacturer 12 to the retail furniture store 14 and thereafter to the retail consumer 8. On the other hand, the returns and complaints originate from the retail consumer 8 back both to the retail furniture store 14 and to the bedding manufacturer 10 while the furniture manufacturer 12 receives the returns and complaints from the retail furniture store 14.

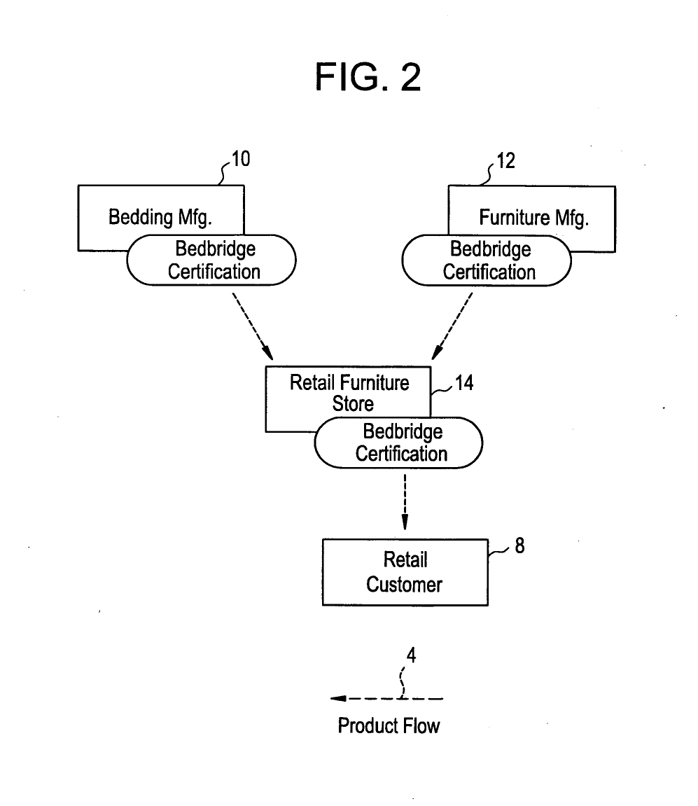

FIG. 2 represents the implementation of the Bedbridge Certification Program with premium bed support systems being introduced to the customer with the aid of all parties involved. The introduction of the Bedbridge Certification Program includes the entire group of parties, that is, the bedding manufacturer 10, the furniture manufacturer 12, the retail furniture store 14 and the retail consumer 8 in the education of the retail consumer 8 to the problem and to the solution. When the retailer steps up to the premium support system, benefits are recognized by each of the participants. The bedding manufacturer 10 has reduced warranty claims. The furniture manufacturer 12 sees increased brand quality recognition. The retailer 14 sees increased profits from premium sales but also is recognized for quality product offerings and sees return business. The customer 8 has full mattress performance and warranty coverage as well as wood bed damage protection.

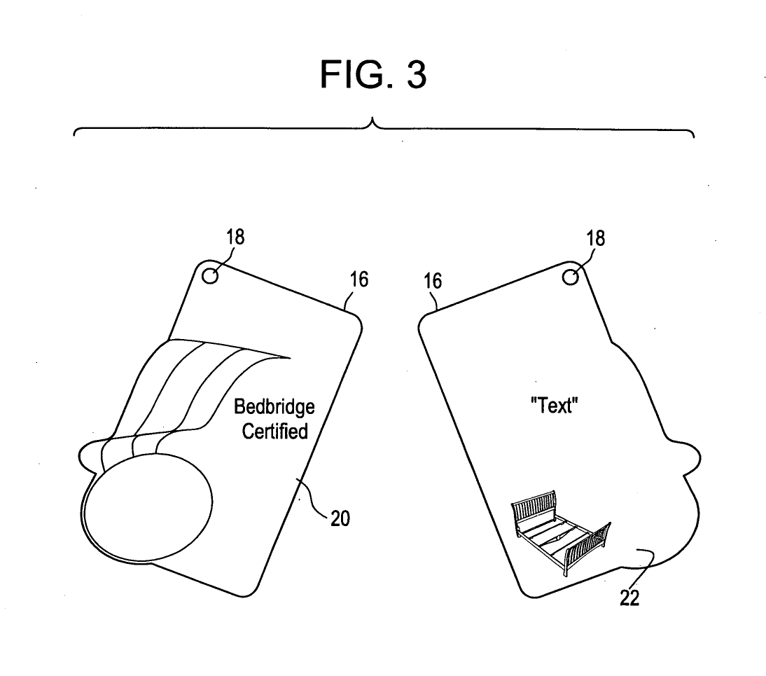

FIG. 3 represents a hangtag 16 that is usable with the present Bedbridge Certification Program. The Bedbridge Certification Program hangtag 16 is used to alert the retail consumer and the retail sales person that a bed room set is capably of being used with a premium bed support like the Bedbeam or the Bedbridge as shown and described in U.S. Pat. No. 6,625,827, issued Sep. 30, 2003 for UNIVERSAL TENSION SPRING SUPPORT MEMBER FOR BED RAILS OR BED FRAME of Polevoy et al, and U.S. Publication 2004/0093670 A1, published May 20, 2004 and entitled SUPPORT MEMBER AND SYSTEM FOR AFFIXATION TO BED RAILS OR BED FRAME of Polevoy et al, and the disclosures of that patent and publication are hereby incorporated herein in their entirety by reference. The hangtag 16 is placed on a retail sales floor typically with a fastening means through a hole 18 in the tag. The hangtag 16 is affixed to the bedding and is a visible reference calling attention to the issue of bed support that is typically under the bed and out of sight.

The issue of premium bedding support is a benefit to the mattress manufacturer and the furniture manufacturer because of the long term benefits to their product structure and performance. Premium support availability and compatibility is also seen by the consumer as an added feature to be set out and will enter into their purchasing discussion.

The front face 20 of the hangtag 16 is brightly colored and has distinct graphics to draw attention to the hangtag 16 and to recognize it as a repeated and desired image throughout a retail showroom. The back face 22 of the hangtag 16 (FIG. 3A) has product features and sales information to build retail consumers and sales associates knowledge concerning the product.

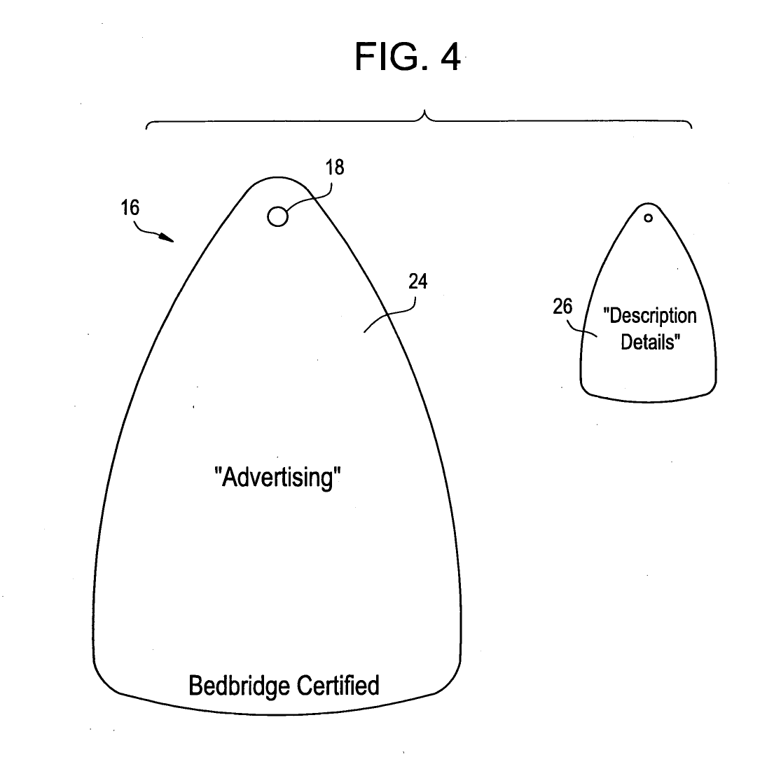

FIG. 4 represents an alternative hangtag 16. The front face 24 of the hang tag 16 displays an advertising message about premium supports and the back face 26 of the hang tag 16 shows alternatives that have multiple embodiments which call out specific product features.

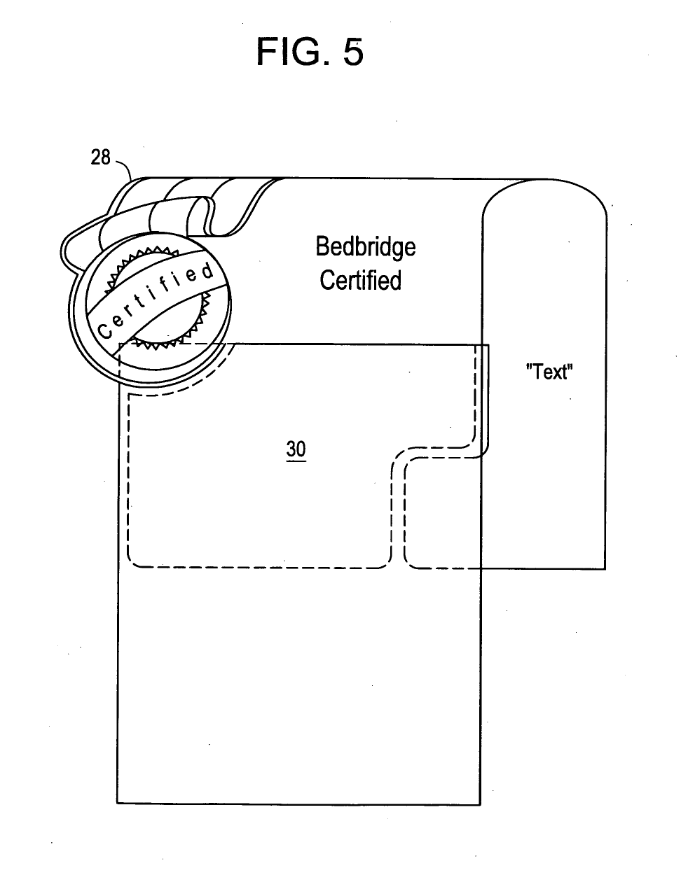

FIG. 5 is a rendering of a hangtag that is used in conjunction with existing purchased hangtag plastic sleeves. The top portion 28 protrudes above the information in the plastic pouch. In this way the hangtag can be added to an existing system without obscuring the original materials 30 or cluttering the merchandise with addition tags.

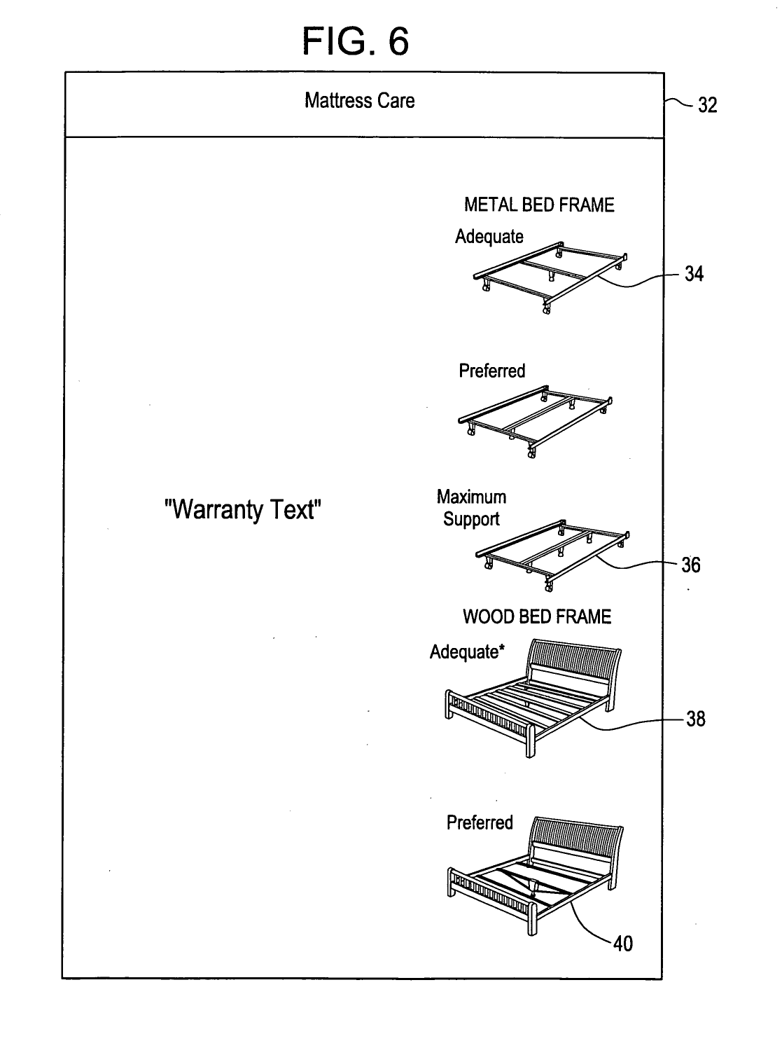

FIG. 6 represents a bedding manufacturer's warranty card 32. Bedding manufacturers have traditionally provided consumers with warranty cards and information that refer to minimum levels of support provided by bed frames and bedding support systems to maintain the warranty valid and in force. This warranty card is different from most mattress warranty cards in that it identifies not only the minimum level 34 of support a bed frame must provide to be in compliance with warrantee requirements, it also references different levels of support culminating with the manufacturers maximum preferred premium bed frame support 36.

This is also true of bed supports that have not typically been choices available to customers. The warranty card 32 identifies the typical adequate support 38 and also the preferred maximum premium support 40.

Retailers have adopted many promotional methods to enhance mattress sales through advertisements and point of purchase material. One of the most common offerings is to provide a “bonus” or “free” bed frame with the purchase of a set of bedding as an inducement to the retail consumer. Accordingly, it is commonplace for furniture retailers to provide promotional quality bed frame or support systems that comply with the minimum levels of support required by the bedding manufacturers. It is also common for a retailer to offer an upgraded bed frame through the use of point of purchase displays. The method typically focuses on minor points of construction. No retailers are currently offering upgrade premium support systems to the consumer.

The retail consumer is approached from a totally different vantage point. Bed frames and support systems are, under the present invention, merchandised by differentiating and pointing out a progression of support. This is best accomplished by incorporating and focusing the attention on the bedding manufacturer's warranty card as a sales tool as is seen in FIG. 6. The warranty card indicates a clear and concise choice for the retail consumer, providing options and levels of support. It will reduce warranty problems for the retail consumer and the mattress manufacturer by recognition of the preferred premium support system provided by certain premium bed frames and bed support systems.

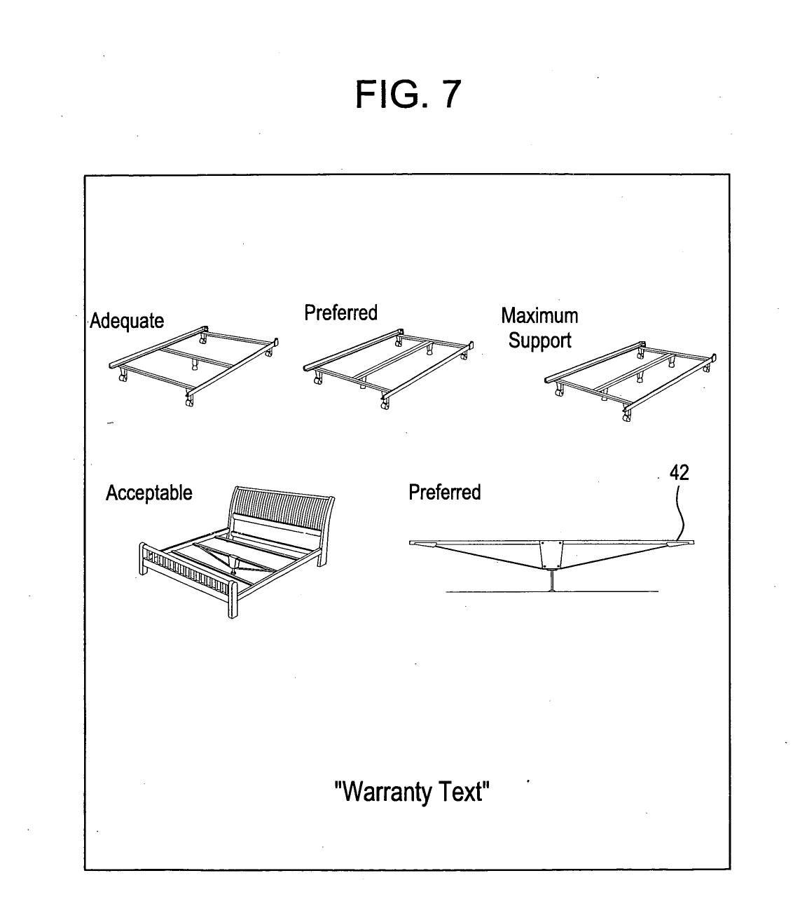

FIG. 7 is an alternate embodiment of a warranty card for a different manufacturer. The Bedbridge is called out specifically as the preferred support system 42.

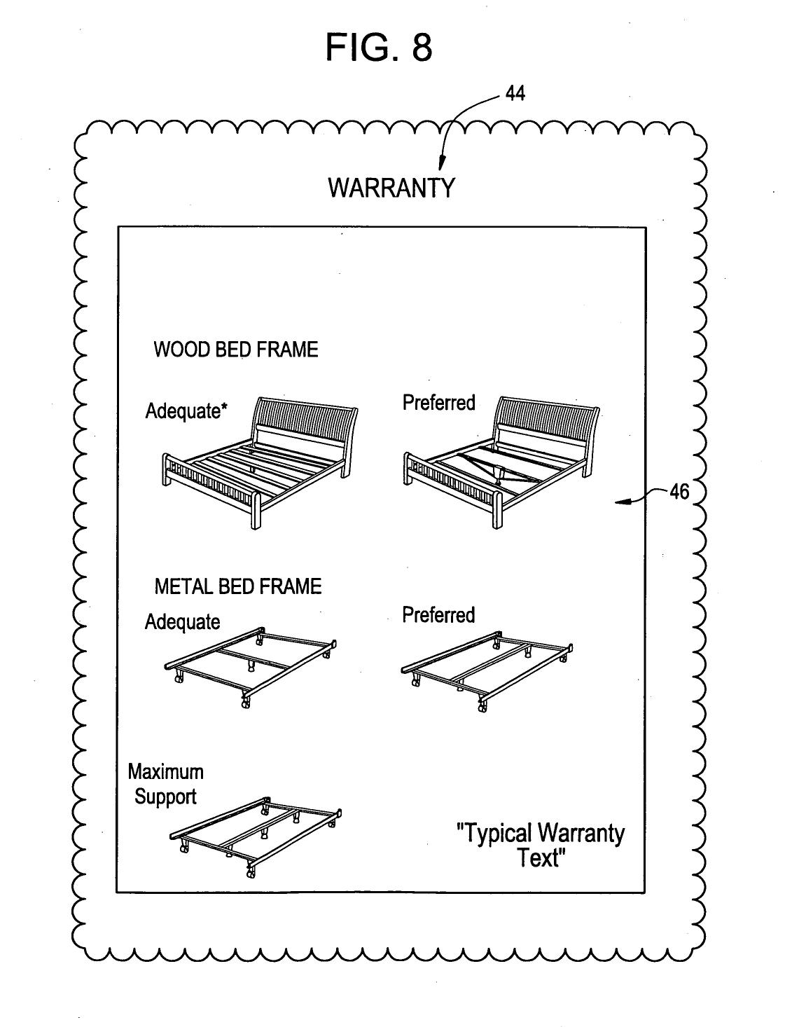

FIG. 8 represents a warranty point of purchase poster. The large text 44 and the oversized graphics 46 spotlight the warranty issues noted on the smaller mattress tag.

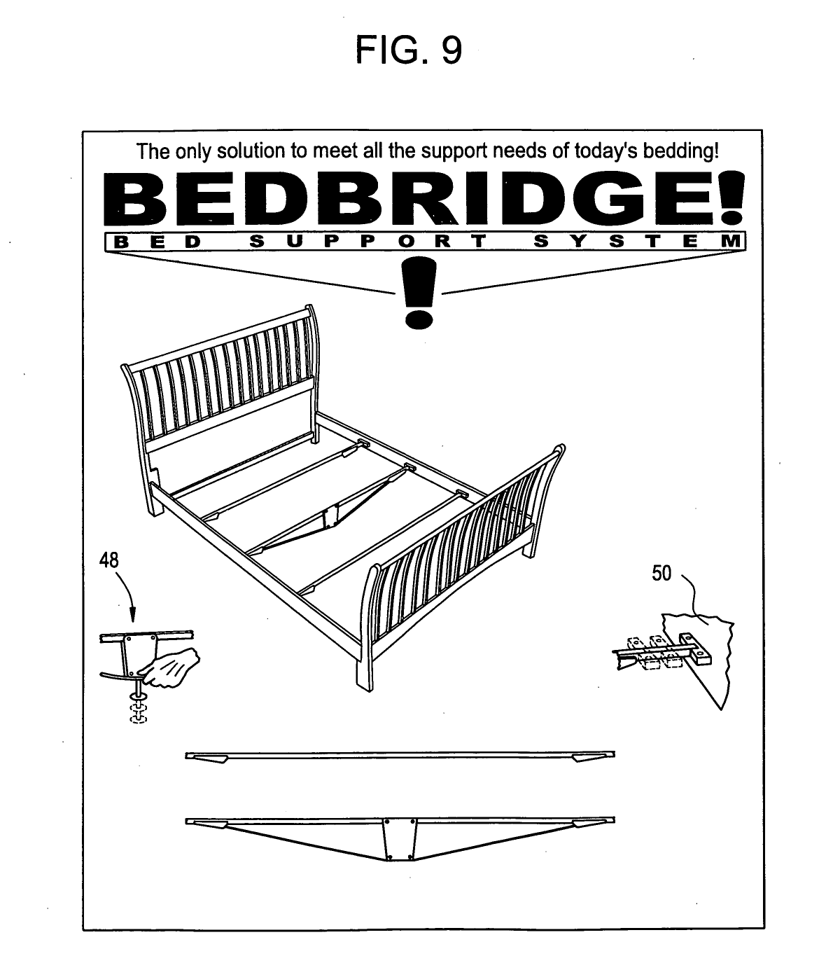

FIG. 9 is a point of purchase poster highlighting the features of a premium support system. This educates the retail consumer and retail sales persons to the ease of assembly 48. the adjustability and the superior strength and durability of the premium support system 50.

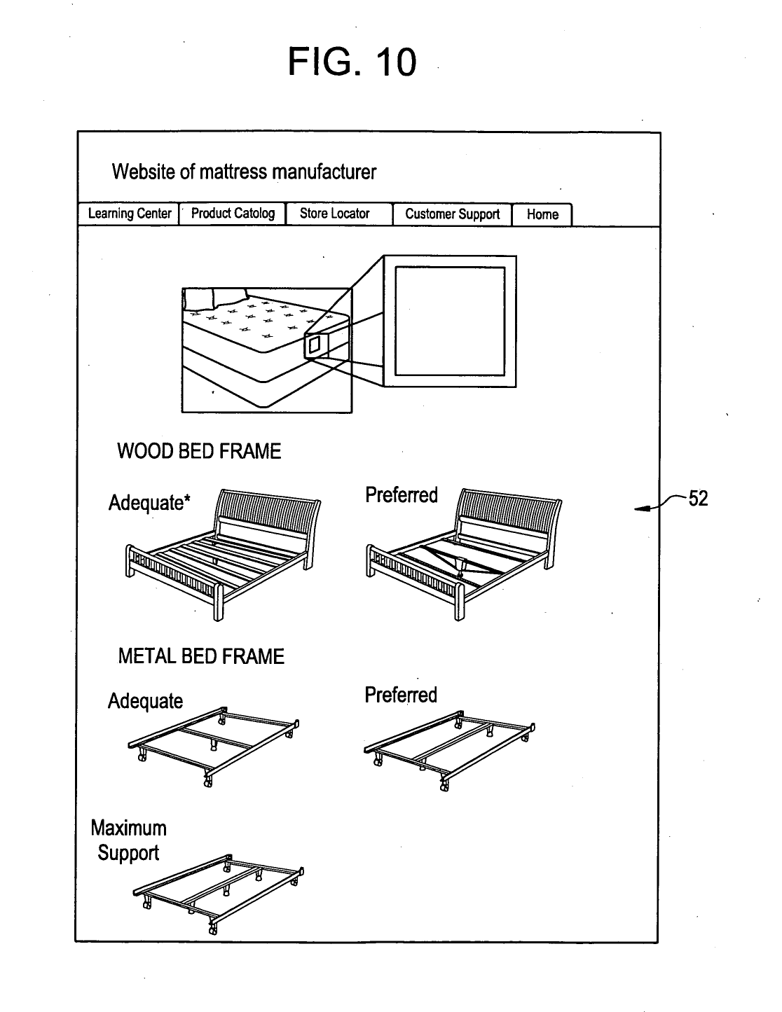

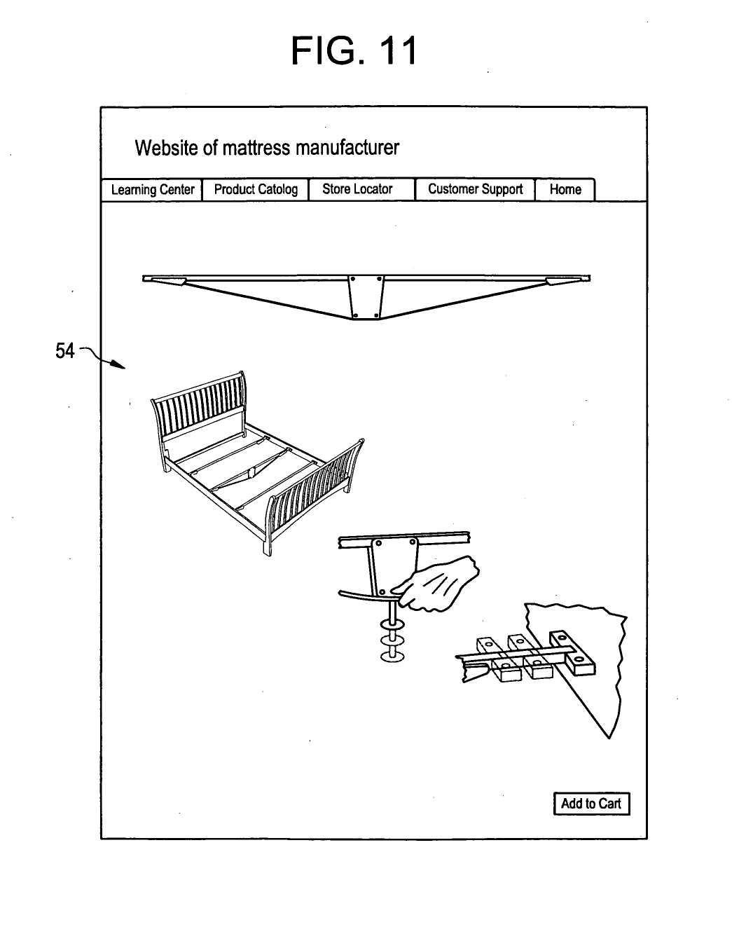

In addition to retail point of purchase and mattress warranty card information the consumer can find warranty information online at mattress manufacturer's websites as shown in FIG. 10 and FIG. 11. This information will bolster the claims made at the retail stores by reiterating the warranty claims of the preferred, premium support system 52. Also, the premium support systems 54 are available for sale over the internet on the same mattress website that refers to them as maximum support. This further complements the same step-up sale created for the retail furniture store.

While the present invention has been set forth in terms of a specific embodiment or embodiments, it will be understood that the present method of merchandising a product herein disclosed may be modified or altered by those skilled in the art to other methods. Accordingly, the invention is to be broadly construed and limited only by the scope and spirit of the claim appended hereto.

What is claimed is:

1. A method for merchandising a premium bed support system directly to retail consumers, said method comprising the step of promoting the use of the features and benefits of the premium bed support system in comparison to a bed support that is included in the cost of a bed purchase.

2. The method as defined in claim 1 wherein the step of promoting the features and benefits comprises promoting the features and benefits of the premium bed support system in comparison to a bed support that is included in the cost of a wooden bed purchase the includes a headboard, footboard and side rails.

3. The method as defined in claim 1 wherein the step of promoting the features and benefits comprises promoting the features and benefits of the premium bed support system in comparison to a bed support that is included in the cost of a bed having a metal frame.

4. The method as defined in claim 1 wherein the step of promoting the use comprises providing a bedding manufacturers warranty card disclosing the features and benefits of the premium bed support system used in conjunction with a wooden bed.

5. The method as defined in claim 1 wherein the step of promoting the use comprises providing a hangtag to notify the consumer of the features and benefits of the premium bed support system.

6. The method as defined in claim 5 wherein the step providing a hangtag comprises attaching a hangtag to bedding in a retail furniture store.

7. The method as defined in claim 5 wherein the step providing a hangtag comprises attaching a hangtag to a wooden bed in a retail furniture store.

8. The method as defined in claim 1 wherein the step of promoting the use comprises providing a sales brochure to retail sales representatives of a retail furniture store providing information relating to the features and benefits of the premium bed support system.

9. The method as defined in claim 1 wherein the step of promoting the use comprises providing a poster to be displayed in a retail furniture store providing information relating to the features and benefits of the premium bed support system.

10. The method as defined in claim 1 wherein the method further comprises the step of charging a premium price for the premium bed support system over the standard bed support system normally provided by the retail furniture store.

11. The method as defined in claim 1 wherein the method further comprises the substituting of the premium bed support system in place of the standard bed support system normally provided by the furniture manufacturer as an added focal point to enhance the saleability of the bed compared to competitive products.

12. A method for merchandising a premium bed support system to retail consumers, said method comprising the step of educating the retail consumer to the availability of a premium bed support system for supporting a box spring and mattress that exceeds the minimum standards required for support of the box spring and mattress as noted in the warranty of the bedding manufacturer.

13. The method of merchandising a premium bed support system as defined in claim 12 wherein the step of educating the retail consumer comprises providing a web site having information thereon that describes the features and benefits of the premium bed support system.

14. The method of merchandising a premium bed support system as defined in claim 12 wherein the step of educating the retail consumer comprises providing written material at the retail furniture store that describes the features and benefits of the premium bed support system.

15. The method of merchandising a premium bed support system as defined in claim 14 wherein the step of providing written material at the retail furniture store comprises providing a hangtag affixed to bedding displayed at the retail furniture store.

16. The method of merchandising a premium bed support system as defined in claim 14 wherein the step of providing written material at the retail furniture store comprises providing a warranty card that identifies the premium bed support system and offers that system as an alternative to a support system that only meets the minimum requirement to meet the warranty of the bedding manufacturer.

17. The method of merchandising a premium bed support system as defined in claim 14 wherein the step of providing written material at the retail furniture store comprises providing a written comparison of the premium bed support system against a support system that only meets the minimum requirement of the warranty of the bedding manufacturer.

18. The method of merchandising a premium bed support system as defined in claim 17 wherein the step of providing a written comparison comprises providing a written comparison on the warranty card of the bedding manufacturer.

19. The method of merchandising a premium bed support system as defined in claim 17 wherein the step of providing a written comparison comprises providing a written comparison on a hangtag affixed to bedding on display at the retail furniture store.

20. A method of educating a retail consumer as to the availability of a premium bed support system comprising the step of providing a written or graphic display illustrating the availability and features of the premium bed support system in comparison to a bed support system that only meets the minimum requirement of the warranty of the bedding manufacturer.

21. The method of educating a retail consumer as defined in claim 20 wherein the step of a providing written or graphic display comprises providing a written or graphic display on a website available on the interne.

22. The method of educating a retail consumer as defined in claim 20 wherein the step of providing written or graphic display comprises providing a hangtag proximate to bedding to be supported on the premium bed support system.

23. The method of educating a retail consumer as defined in claim 20 wherein the step of providing a written or graphic display comprises providing a warranty card proximate to bedding to be supported on the premium bed support system.

24. The method of educating a retail consumer as defined in claim 20 wherein the premium support system is understood to be by design installable in an error free manner.

25. The method of merchandising a premium bed support system comprising the step of using a warranty card of a bedding manufacturer to promote the sale of a premium bed support system that is adapted to support that bedding.
